(19) United States
(12) Patent Application Publication
(10) Pub. No.: US 2023/0404095 A1
(43) Pub. Date: Dec. 21, 2023

(54) Zero-Sugar and Zero-Net Carb Dairy Product and Preparation Thereof

(71) Applicant: General Mills, Inc., Minneapolis, MN (US)

(72) Inventors: Ariel J. Buehler, Minneapolis, MN (US); Steve Cheruvathoor, Blaine, MN (US); James D. Fischer, Maplewood, MN (US); Jerry L. Fultz, New Hope, MN (US); Padmini Iyer, Thane (IN); Christine S. T. Ng, Minneapolis, MN (US)

(21) Appl. No.: 18/209,527

(22) Filed: Jun. 14, 2023

Related U.S. Application Data
(60) Provisional application No. 63/352,498, filed on Jun. 15, 2022.

(51) Int. Cl. A23C 9/142; A23C 9/123; B01D 61/14; B01D 61/16; B01D 61/18

(52) U.S. Cl. CPC A23C 9/1422; A23C 9/123; B01D 61/146; B01D 2311/04; B01D 61/18; A23C 2210/202; B01D 2315/16; B01D 61/16

(57) ABSTRACT

A zero-sugar and zero-net carb dairy product includes a washed fermented dairy material. Separation technology for the removal of sugars and organic acids from a fermented dairy material to produce the zero-sugar and zero-carb dairy product includes the repetition of a wash cycle involving a dilution step and a separation step. The separation technology achieves at least an 60% reduction in total sugars, at least an 80% reduction in organic acids and at least a 60% reduction in total carbohydrates. The zero-sugar and zero-net carb dairy product has a protein to carbohydrate ratio at least double that of conventional low-carb dairy products.

### CROSS REFERENCE TO RELATED APPLICATIONS

This application claims the benefit of U.S. Provisional Patent Application No. 63/352,498, filed on Jun. 15, 2022 and titled “ZERO-SUGAR AND ZERO-NET CARB DAIRY PRODUCT AND PREPARATION THEREOF”. The entire content of this application is incorporated by reference.

### FIELD OF THE INVENTION

The invention generally pertains to cultured dairy products (animal-derived or non-animal-derived) and methods of making cultured dairy products. More particularly, the invention is related to cultured dairy products, such as yogurt (animal-derived or non-animal-derived), that are substantially free of sugars and substantially free of organic acids, as well as technology for preparing cultured dairy products that are substantially free of sugars and substantially free of organic acids.

### BACKGROUND OF THE INVENTION

Many consumers enjoy yogurt and other similar dairy products but there is growing demand for such products to have a reduced sugar content and/or a low total or net carbohydrate content. Traditionally, yogurt and other similar dairy products are made by a process that includes a step of fermenting a dairy material with, e.g., lactic acid bacteria. However, a significant amount of carbohydrates (e.g., unfermented sugars) typically remain in the fermented dairy product. Some manufacturers have attempted to reduce the sugar content of fermented dairy products in different ways, such as by first filtering the starting dairy material to reduce the sugar content before the fermentation step or by adding additional bacterial cultures or enzymes to achieve higher/complete conversion of the sugars during the fermentation step. However, such processes typically require longer fermentation and the resulting product still includes a level of carbohydrates that is reported on its nutrition label and impacts the caloric and net carbohydrate content of the product.

### SUMMARY OF THE INVENTION

The present invention is directed to a dairy product being zero-sugar and having zero net carbs. The present invention is further directed to separation technology for removal of sugars and organic acids from fermented dairy material to produce a dairy product being zero-sugar and having zero net carbs.

A process in accordance with the present invention includes providing a fermented dairy material having sugars and organic acids. Preferably, the fermented dairy material provided is a yogurt. The provided fermented dairy material is subjected to a dilution step with a dilution liquid and then a separation step. In the separation step, liquid including diffused sugars (e.g., unfermented lactose, galactose, etc.) and organic acids from the dairy material is separated by one or more separation methods. Examples of the one or more separation methods include but are not limited to membrane filtration (e.g., using a cross-linked membrane, separation is based on molecular weight, chain length, or other properties of the solutes), centrifugation, regular filtration, ion exchange or chromatography separation. A washed fermented dairy material and a filtrate are formed.

The wash cycle, i.e., the combined steps of diluting and separating, is repeated at least once more, where the washed fermented dairy material is subjected to further dilution and separation. The wash cycle is repeated until the desired levels of sugars and organic acids are achieved in the washed fermented dairy material. The number of times the wash cycle is repeated is primarily dependent upon the levels of sugars and organics acids in the provided fermented dairy material and the levels of sugars and organic acids desired and/or required in the final product. The number of times the wash cycle is repeated also depends upon the equipment employed. In some embodiments, the wash cycle is performed at least four times (e.g., six times).

A system in accordance with the present invention includes multiple separation stages (i.e., at least two separation stages). In some embodiments, the system includes at least four stages (e.g., six stages). In each stage, a fermented dairy material (initial fermented dairy material in the first stage and washed fermented dairy material in subsequent stages) is introduced via an inlet and subjected to dilution with a dilution liquid (also introduced via an inlet) and then separated via one or more separation technologies. Examples of the one or more separation technologies include but are not limited to membrane filtration (e.g., using a cross-linked membrane, separation is based on molecular weight, chain length, or other properties of the solutes), centrifugation, regular filtration, ion exchange or chromatography separation. In some embodiments, one or more of spiral wound, plate and frame, or ceramic tubular membrane filtration (e.g., ultrafiltration (UF) membranes) in employed in each stage.

A washed fermented dairy material and a filtrate are generated in each stage, exiting at respective outlets. When applicable (e.g., if the dairy material has been washed less than four times), the washed fermented dairy material is then introduced to an inlet of the next stage for further processing while the filtrate is removed, potentially for other uses.

The process and system of the present invention achieve at least an 60% reduction (e.g., at least a 90% reduction) in total sugars, at least an 80% reduction in organic acids (e.g., 82%) and at least a 60% reduction in total carbohydrates (e.g., at least 90%).

In some embodiments, the treated dairy material may be combined with a prep to create a zero-sugar (i.e., less than 0.29% sugar) and zero-net carb dairy product having a desired consistency, calorie content and/or texture.

A dairy product in accordance with the present invention is zero-sugar and has zero net carbs. Preferably, the dairy product is a yogurt or a cream cheese. The dairy product includes a washed fermented dairy material having an organic acid content of 0.7 wt % or less and a protein to carbohydrate ratio of at least 7.8:1. By way of a specific example, a 150 g serving of the zero-sugar and zero-net carb dairy product has 50-70 calories.

Compared to prior art dairy products marketed as being low in carbohydrates and sugars, the dairy product of the present invention is truly zero-sugar and has zero net carbs. Moreover, the dairy product of the present invention has at least 60% fewer carbohydrates and a significantly larger protein to carbohydrate ratio, i.e., at least double the prior art ratio (e.g., at least 3.95:1)

### BRIEF DESCRIPTION OF THE DRAWINGS

FIG. 1 is a diagram illustrating a process in accordance with the present invention.

FIG. 2 is a diagram illustrating a system in accordance with the present invention.

FIG. 3 is a mass balance diagram showing the split of protein, sugars and organic acids from an initial fermented dairy material into a washed fermented dairy product and whey generated in a process according with the present invention.

### DETAILED DESCRIPTION

Initially, it should be noted that the embodiments of the present invention described below are not intended to be exhaustive or limit the invention to the precise forms disclosed in the following detailed description. Rather a purpose of the embodiments chosen and described is so that the appreciation and understanding by others skilled in the art of the principles and practices of the present invention can be facilitated. Also, it should be realized that the embodiments described in the below paragraphs for the inventive process, system and/or product are not mutually exclusive and therefore can be combined in connection with other embodiments.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

The term “dairy” refers to materials, compositions or products, based on or derived from, at least partially, animal milk (e.g., cow milk, sheep milk, goat milk, water buffalo milk, or bison milk, preferably cow milk) or non-animal milk ingredients (e.g., plant-based materials). Non-animal milk ingredients can include ingredients produced by precision fermentation which involves programming simple microorganisms (e.g., using recombinant DNA technology or biomass or cellular fermentation) to produce specific, desired organic molecules (e.g., proteins such as casein). The terms “fermented dairy” or “cultured dairy” are used herein to describe acidic or fermented dairy issued from a step of acidification of a liquid material (“starting dairy material”), at least a portion of which is a dairy liquid material. Acidification can be performed by fermentation. Lactic acid bacteria are typically used for the fermentation process. Lactic acid bacteria convert lactose in a starting dairy material (e.g., milk) to lactic acid and galactose (and/or other simple sugars). In turn, the pH is lowered which causes protein in the dairy material to precipitate and form a curd. The curd is a protein matrix in which a liquid whey component is entrapped. Fermented dairy can be strained or unstrained (e.g., using ultrafiltration or centrifugal separation) and can further include a prep (see definition for “prep” below). “Strained fermented dairy” has a thicker consistency relative to unstrained fermented dairy because most of the whey is removed from the curd as a consequence of a separation step. “Washed fermented dairy” refers to fermented dairy which has been treated with a dilution liquid and subsequently has some, most or all of its whey or other generated liquid (e.g., wash water) separated therefrom. “Dilution liquid” is an aqueous liquid in which water-soluble small molecules (e.g., sugars and organic acids) that are found in fermented dairy can be diffused. The aqueous liquid with the diffused solutes therein (aqueous solution) can be separated as a filtrate. The term “filtrate” refers to the portion (or entirety) of this aqueous solution that is separated and is not limiting in regards to the particular separation technology employed in the separation (e.g., not limited to regular filtration). For example, the term “filtrate” can encompass “permeate” (e.g., from membrane filtration) or “supernatant” (e.g., from centrifugation) or other analogous terms known to those in the art. “White mass” or “white base” are terms used to refer to the material, primarily containing the curd/protein matrix, that remains after most (e.g., over 75%) or all of the whey component/filtrate/wash water is separated from a fermented dairy material/diluted dairy material. White mass typically includes casein in the form of a thick gel and is so-called because it is typically white in color. Non-limiting examples of forms of fermented dairy products (animal-derived or non-animal derived) include, for example, products in the form of yogurt, Greek yogurt (strained), fresh cheeses, strained yogurt drinks and frozen strained yogurt products.

The term “diafiltration” refers to a dilution process in which the concentration of solutes (e.g., sugars, organic acids) is reduced in an aqueous phase such that when a subsequent separation occurs (e.g., using tangential flow filtration), a more dilute aqueous phase is removed and the remaining aqueous phase in the washed retentate has a reduced concentration of the solutes. In contrast, a regular membrane separation process aims at concentration of ingredients, with partial removal of solutes happening as a by-product of the process.

The term “sugar” or “sugars” refers to one or more particular carbohydrates that are naturally found in dairy material, e.g., lactose, galactose, glucose, galacto-oligosaccharides, or mixtures thereof. “Added sugar” refers to non-naturally occurring sweet-tasting carbohydrates that are added to a product during processing/manufacturing. The terms “zero-sugar” or “substantially free of sugars” as used herein refer to the combined amounts of sugar and added sugar (i.e., “total sugars”) in a material or product being undetectable or less than 0.29% by weight (e.g., less 0.17% by weight or 0.128% by weight).

The term “organic acid” or “organic acids” refers to one or more particular acidic organic compounds that occur in dairy material naturally or are produced during fermentation of dairy material, such as, but not limited to acetic acid, citric acid, fumaric acid, gluconic acid, malic acid, lactic acid, oxalic acid, propionic acid, quinic acid, succinic acid, tartaric acid, butyric acid, or mixtures thereof. The term “substantially free of organic acids” as used herein refers to the amounts of organic materials in a material or product being undetectable or less than 0.7% by weight (e.g., no more than 0.2% by weight or 0.101% by weight).

The term “carbohydrates” refers to components other than crude protein, fat, moisture, or minerals that can be found in dairy material or products. Carbohydrates include, e.g., sugar, added sugar and organic acid as defined herein as well as dietary fiber and sugar alcohols. The terms “total carbohydrates” or “total carbohydrate content” refer to the amount of carbohydrates in a product serving (e.g., in grams). The terms “net carbs” or “net carbohydrates” or “net carbohydrate content” are used herein to refer to the amount of carbohydrates in a product serving that are digestible. Typically, net carbs are calculated by subtracting the amounts of, e.g., dietary fiber and sugar alcohol (e.g., erythritol) in a serving of a product (e.g., in grams) from the total carbohydrates in the serving, as dietary fiber and sugar alcohols are largely indigestible. If present, sucralose (a sweetener) is another ingredient that is subtracted from the total carbohydrates when calculating net carbs. The terms “zero-net carb” or “zero net carbs” refers to the net carbohydrate content of a material or product being less than 0.5 grams per serving.

The term “protein to carbohydrate ratio” refers to a ratio by weight of protein to carbohydrate, i.e., grams of a protein per gram of carbohydrate in a certain material, composition or product.

As used herein, “prep” or “blank prep” refers to a preparation used to modify the taste, mouthfeel and/or texture of a dairy material, e.g., a fermented dairy material. A prep can include ingredients such as sweetening agents (e.g., sugar alcohols, allulose or sucralose), flavoring agents, coloring agents and stabilizers (e.g., guar gum). In some embodiments, a prep includes a fruit juice and/or a fruit puree. A prep typically does not contain dairy materials itself and is typically added to the dairy material as part of a last step in preparing a dairy-based product. However, a prep can be included with a fermented dairy material before such a material is subjected to the method and/or system of the present invention (i.e., the combination of fermented dairy and prep can be all or part of the provided starting fermented dairy material that is subjected to wash cycles).

There is an ever-growing demand from consumers that want to generally reduce sugar and/or carbohydrates in their diet without compromising on taste and texture. There is a wide range of dairy products (e.g., yogurts) in the “weight management,” “healthy living” or “free from sugar” product range that do not contain any added sugars. But these products still contain some naturally occurring sugars such as lactose. In the case of fermented dairy products, even though lactose gets converted to lactic acid during fermentation, there is still unfermented lactose (and/or galactose) that remains in the product. Unfermented sugars as well as organic acids that are produced during fermentation (e.g., lactic acid) and remain in the product are accounted for on the product's nutrition label, in particular contributing to the “total carbohydrates” component, the “net carbs” component (if displayed), and the “sugars” component.

The present invention is directed to a dairy product being zero-sugar and having zero net carbs. The present invention is further directed to separation technology for removal of sugars and organic acids from fermented dairy material to produce a dairy product being zero-sugar and having zero net carbs.

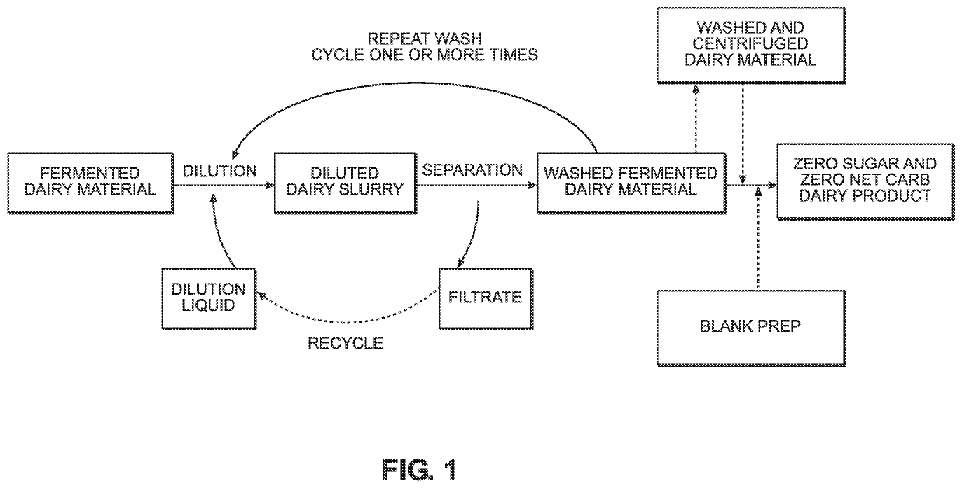

FIG. 1 illustrates a process in accordance with the present invention. Initially, a fermented dairy material is provided. In some embodiments, the fermented dairy material provided is a yogurt. For example, a Greek yogurt or yogurt made from ultrafiltered milk. In some embodiments, the fermented dairy material provided is suitable for forming a cream cheese product. However, other fermented dairy materials can be provided.

Next, the provided fermented dairy material is subjected to a dilution step. A dilution liquid is provided and mixed with the fermented dairy material (e.g., by whisking) to form a diluted dairy slurry. In some embodiments, the dilution liquid consists essentially of water. In some embodiments, the volume of dilution liquid provided is 15-50% (e.g., 15-30%) of the volume of the initially provided fermented dairy material. In some embodiments, the volume of dilution liquid provided is up to 150% (e.g., 125%) of the volume of the initially provided fermented dairy material. In some embodiments, the volume of dilution liquid provided is up to 300% of the volume of the initially provided fermented dairy material. Adding the dilution liquid to the fermented dairy material allows small water-soluble molecules such as sugars (e.g., unfermented lactose, galactose), organic acids and minerals present in the liquid whey of the fermented dairy material to diffuse into the dilution liquid.

The diluted dairy slurry is then subjected to a separation step to form a washed fermented dairy material and a filtrate. In this separation step, the dilution liquid including diffused sugars (e.g., unfermented lactose, galactose) and organic acids therein is separated from the white base of the diluted dairy slurry by one or more separation methods. Examples of the one or more separation methods include but are not limited to membrane filtration (e.g., using a cross-linked membrane, separation is based on molecular weight, chain length, or other properties of the solutes), centrifugation, regular filtration, ion exchange or chromatography separation. The separated white base is considered a washed fermented dairy material, as it has gone through the above dilution and separation steps. As shown by a dotted arrow line in FIG. 1, the filtrate may optionally be recycled and used in further dilution steps as part of (or entirely) the dilution liquid.

The wash cycle, i.e., the combined steps of diluting and separating, is repeated at least one more time (e.g., iterative dilution; batch operation), where the washed fermented dairy material is subjected to further dilution and separation to achieve the desired sugar and organic acid removal. In some embodiments, the wash cycle achieves a washed fermented dairy material having increased viscosity. The number of times the wash cycle is repeated depends upon the choice of equipment as well as the amount of sugar and organic acid in the starting provided fermented dairy material and the desired levels of sugar and organic acid in the product. In some embodiments, the wash cycle is performed at least four times (e.g., six times, or up to 13 times). In some embodiments, the wash cycles are performed continuously. With each cycle, both the filtrate and the washed fermented dairy material contain fewer amounts of sugars and organic acids (see Example 4). The wash cycle is ideally repeated until desired levels of sugar and organic acids are achieved in the washed fermented dairy material. As such, the number of wash cycles typically depends on the amount of sugar and organic acid in the starting provided fermented dairy material, the solubility of the sugars and organic acids (i.e., solutes) in the dilution liquid, and/or the equipment design (e.g., throughput and residence time and, if membrane filtration is employed, the pore size of the membrane and the interactions between the membrane and the solutes). In some embodiments, the wash cycle is repeated until the washed fermented material has less than 2.5% total carbohydrates (e.g., 1.6% or less, 0.4% or less), less than 0.5% total sugars (e.g., between 0.100% and 0.350%), less than 0.7% organic acids, at least 11% protein, and/or a protein to carbohydrate ratio of at least 7.8:1 (e.g., at least 33:1). When a cream cheese product is being made, the method of making the cream cheese product in accordance with a method of the present invention is less time consuming than the traditional or conventional method of making cream cheese.

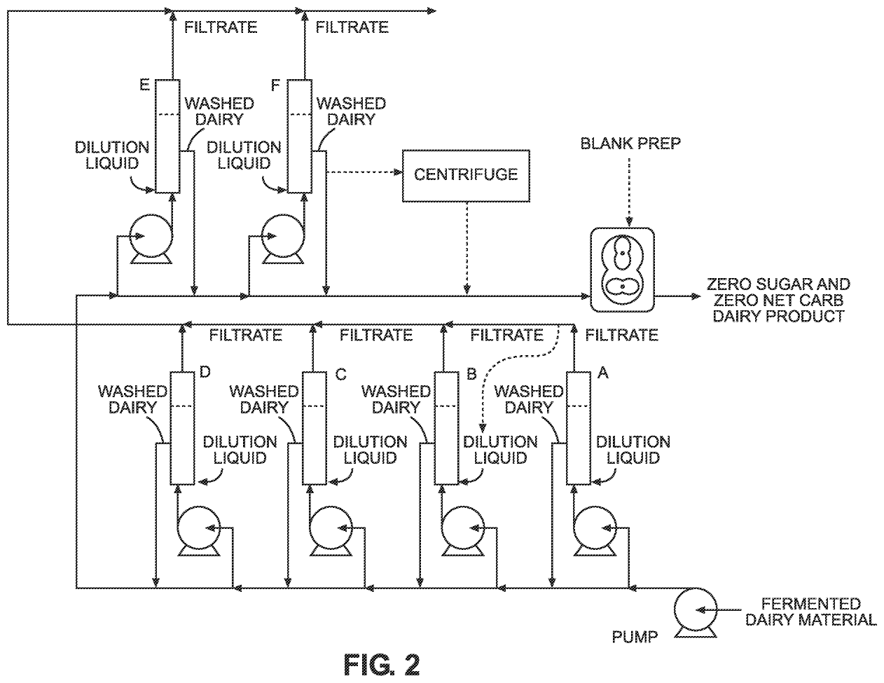

In some embodiments, the repeating of the wash cycle is achieved using multiple separation stages as described with reference to FIG. 2. FIG. 2 illustrates a system in accordance with the present invention for preparing a zero-sugar and zero-net carb dairy product. Each separation stage A-F represents one wash cycle. As shown in FIG. 2, six stages are employed. However, as little as two stages or as many as ten stages could be employed in accordance with the present invention.

In each stage, a fermented dairy material (initial fermented dairy material in stage A and washed fermented dairy material in subsequent stages B-F) is introduced via an inlet and, e.g., a pump and subjected to dilution with a dilution liquid (also introduced via an inlet) and then separation via one or more separation technologies. Examples of the one or more separation technologies include but are not limited to membrane filtration (e.g., using a cross-linked membrane, separation is based on molecular weight, chain length, or other properties of the solutes), centrifugation, regular filtration, ion exchange or chromatography separation. In some embodiments, one or more of spiral wound, plate and frame, or ceramic tubular membrane filtration (e.g., ultrafiltration (UF) membranes) is employed in each stage. A spiral wound UF membrane includes flexible membranes wound around a filtrate collection tube, with a pair of the membranes being separated by a permeate spacer mesh or grid to allow for fluid flow. In some embodiments, one or more of the separation stages is configured to perform diafiltration. The fermented dairy inlet and the dilution liquid inlet may be distinct inlets or the same inlet. When membrane separation technology is used, pressure from a fermented dairy material introduction pump can be used to cause filtrate to separate from the fermented dairy material through the one or more membranes. In the case of a spiral wound membrane, the pressure causes the filtrate to enter the collection tube. In some embodiments, the one or more membranes employed in the system of the present invention have semi-permeable walls, featuring pores which allow substances of molecular weight up to 25,000 Da to exit. Preferably, the membrane specifications are selected based upon the viscosity of the material being separated in order to prevent unnecessary protein loss. In some embodiments, as the washed fermented dairy material increases in viscosity with each wash cycle/stage, larger spacers are used for the spiral wound UF membranes. In some embodiments, the introduction pump at each subsequent stage applies more pressure compared to the pump used in the previous stage.

A washed fermented dairy material and a filtrate are generated in each stage, exiting at respective outlets. When applicable (e.g., if the dairy material has been washed less than four times), the washed fermented dairy material is then introduced to an inlet of the next stage for further processing while the filtrate is removed, potentially for other uses. Optionally, the filtrate is processed (e.g., to remove solutes) and recycled to be used in or as the subsequent stage's dilution liquid. See the dashed line between stages A and B. In some embodiments, the volume of dilution liquid added at the beginning of a wash cycle equals the volume of filtrate removed from the previous cycle. In some embodiments, the volume of dilution liquid added at the beginning of a wash cycle is less than the volume of filtrate removed from the previous cycle to allow for simultaneous washing and concentration of the washed fermented dairy material.

As shown in both FIGS. 1 and 2, the washed fermented dairy material, after the completion of the wash cycles, can be optionally subjected to centrifugation to yield a washed and centrifuged dairy material.

The process and system of the present invention achieves at least an 60% reduction (e.g., at least a 90% reduction) in total sugars, at least an 80% reduction in organic acids (e.g., 82%) and at least a 60% reduction in total carbohydrates (e.g., at least 90%). In some embodiments, a starting provided fermented dairy material having 0.8% sugars is treated using the process and/or system of the present invention to undergo at least a 63% reduction in sugars and achieve a zero-sugar (i.e., less than 0.29% sugar) product.

In some embodiments, after the completion of the wash cycles and optional centrifugation, the treated dairy material may be combined with a prep to create a zero-sugar (i.e., less than 0.29% sugar) and zero-net carb dairy product having a desired consistency, calorie content and/or texture. The term “prep” is defined above. In some embodiments, 65-100% (e.g., 65-75%) of the dairy product is the washed fermented dairy material and 0-35% (e.g., 25-35%) of the dairy product is the prep. The prep in accordance with the present invention does not include added sugars or organic acids such that the resulting dairy product does not have net carbs. In some embodiments, the prep includes allulose and/or sucralose as sweetening agents.

A dairy product in accordance with the present invention is zero-sugar and has zero net carbs. Preferably, the dairy product is a yogurt or a cream cheese. The dairy product includes a washed fermented dairy material component having an organic acid content of 0.7 wt % or less. In some embodiments, the washed fermented dairy material component of the dairy product has less than 2.5% total carbohydrates (e.g., 1.6% or less, 0.4% or less), less than 0.5% total sugars (e.g., between 0.100% and 0.350%), less than 0.7% organic acids, at least 11% protein, and/or a protein to carbohydrate ratio of at least 7.8:1 (e.g., at least 33:1). In some embodiments, a 150 g serving of the zero-sugar and zero-net carb dairy product has 50-70 calories. In some embodiments, the dairy product further includes a prep. The dairy product can include 0-35 wt % prep (e.g., 25-35%) and 65-100 wt % (e.g., 65-75%) washed fermented dairy material having an organic acid content of 0.7 wt %.

Compared to prior art dairy products marketed as being low in carbohydrates and sugars, the dairy product of the present invention is truly zero-sugar and has zero net carbs. Moreover, the dairy product of the present invention has at least 60% fewer carbohydrates and a significantly larger protein to carbohydrate ratio, i.e., at least double the prior art ratio (e.g., at least 3.95:1).

As previously mentioned, it should be realized that the embodiments described in the above paragraphs for the inventive process, system and/or product are not mutually exclusive and therefore can be combined in connection with other embodiments. For instance, the invention encompasses a dairy product embodiment which includes a prep and has 50-70 calories per 150 g serving.

### EXAMPLES

### Example 1—Four-Stage Washing of 0% Fat Greek Yogurt to Reduce Sugars

1) 2000 grams (1 volume) of a commercially available 0% milk fat Greek yogurt (fermented dairy material) is provided and then mixed well with 0.3 volume of water to form a diluted Greek yogurt slurry.
2) The diluted Greek yogurt slurry is filtered through a 20-25 μm mesh diafiltration membrane to form a washed Greek yogurt white base.
3) To the washed Greek yogurt white base, additional water (0.15-0.3 volume) is added and stirred.
4) Steps 2 and 3 are repeated until the yogurt has been washed (i.e., diluted and filtered) four total times. The four-time washed white base is analyzed without being further diluted.

As shown in Table 1, the four-stage washing achieved a 90% reduction in total sugars (from 3.39% to 0.348%).

TABLE 1

| | | Total | | | | | | |
|---|---|---|---|---|---|---|---|---|
| | Protein | Sugars | Galactose | Fructose | Glucose | Sucrose | Maltose | Lactose |
| | (%) | (%) | (%) | (%) | (%) | (%) | (%) | (%) |
| 0% Fat | 10.3 | 3.39 | 0.67 | <0.1 | <0.1 | <0.1 | <0.1 | 2.72 |
| Greek | | | | | | | | |
| Yogurt | | | | | | | | |
| Base | | | | | | | | |
| Starting | | | | | | | | |
| Fermented | | | | | | | | |
| Material | | | | | | | | |
| White | 12.6 | 0.348 | <0.1 | <0.1 | <0.1 | <0.1 | <0.1 | 0.348 |
| Base | | | | | | | | |
| After 4 | | | | | | | | |
| Washes- | | | | | | | | |
| Filtration | | | | | | | | |

### Example 2—Six-Stage Washing of 0% Fat Greek Yogurt to Reduce Sugars

1) 2000 grams (1 volume) of a commercially available 0% milk fat Greek yogurt (fermented dairy material) is provided and then mixed well with 0.3 volume of water to form a diluted Greek yogurt slurry.
2) The diluted Greek yogurt slurry is filtered through a 20-25 μm mesh diafiltration membrane to form a washed Greek yogurt white base.
3) To the washed Greek yogurt white base, additional water (0.15-0.3 volume) is added and stirred.
4) Steps 2 and 3 are repeated until the white base has been washed (i.e., diluted and filtered) six total times. The six-time washed white base is analyzed without being further diluted.

As shown in Table 2, the six-stage washing achieved a 97% reduction in total sugars (from 3.39% to 0.102%).

TABLE 2

| | | Total | | | | | | |
|---|---|---|---|---|---|---|---|---|
| | Protein | Sugars | Galactose | Fructose | Glucose | Sucrose | Maltose | Lactose |
| | (%) | (%) | (%) | (%) | (%) | (%) | (%) | (%) |
| 0% Fat | 10.3 | 3.39 | 0.67 | <0.1 | <0.1 | <0.1 | <0.1 | 2.72 |
| Greek | | | | | | | | |
| Yogurt | | | | | | | | |
| Base | | | | | | | | |
| Starting | | | | | | | | |
| Fermented | | | | | | | | |
| Material | | | | | | | | |
| White | 12.7 | 0.102 | <0.1 | <0.1 | <0.1 | <0.1 | <0.1 | 0.102 |
| Base | | | | | | | | |
| After 6 | | | | | | | | |
| Washes- | | | | | | | | |
| Filtration | | | | | | | | |

### Example 3—Six-Stage Washing of 0% Fat Greek Yogurt Plus Centrifugation to Reduce Sugars

1) 2000 grams (1 volume) of a commercially available 0% milk fat Greek yogurt (fermented dairy material) is provided and then mixed well with 0.3 volume of water to form a diluted Greek yogurt slurry.
2) The diluted Greek yogurt slurry is filtered through a 20-25 μm mesh diafiltration membrane to form a washed Greek yogurt white base.
3) To the washed Greek yogurt white base, additional water (0.15-0.3 volume) is added and stirred.
4) Steps 2 and 3 are repeated until the white base has been washed (i.e., diluted and filtered) six total times.
5) The six-time washed yogurt, without being further diluted, is centrifuged to reduce moisture to 73%.

As shown in Table 3, the six-stage washing plus centrifugation effectively achieved a 100% reduction in total sugars (from 3.9% to undetectable levels, i.e., below limit of quantification (LOQ)).

TABLE 3

| | | Total | | | | | | |
|---|---|---|---|---|---|---|---|---|
| | Protein | Sugars | Galactose | Fructose | Glucose | Sucrose | Maltose | Lactose |
| | (%) | (%) | (%) | (%) | (%) | (%) | (%) | (%) |
| 0% Fat Greek | 10.3 | 3.39 | 0.67 | <0.1 | <0.1 | <0.1 | <0.1 | 2.72 |
| Yogurt Base | | | | | | | | |
| Starting | | | | | | | | |
| Fermented | | | | | | | | |
| Material | | | | | | | | |
| White Base | 25.7 | <LOQ | <0.1 | <0.1 | <0.1 | <0.1 | <0.1 | <0.1 |
| After 6 | | | | | | | | |
| Washes- | | | | | | | | |
| Filtration + | | | | | | | | |
| Centrifugation | | | | | | | | |

### Example 4—Tracking Organic Acid Removal Through Six-Stage Washing

1) 500 grams (1 volume) of a commercially available 0% milk fat Greek yogurt (fermented dairy material) is provided and then mixed well with 0.3 volume of water to form a diluted Greek yogurt slurry.
2) The diluted Greek yogurt slurry is filtered through a 50 μm mesh diafiltration membrane to form a washed Greek yogurt white base and a filtrate (wash water). The washed base and wash water are analyzed.
3) To the washed Greek yogurt white base, additional water (0.15-0.3 volume) is added and stirred.
4) Steps 2 and 3 are repeated until the white base has been washed (i.e., diluted and filtered) and analyzed six total times.

As shown in Table 4, the six-stage washing achieved an 82% reduction in organic acids.

TABLE 4

| | Lactic acid | Citric Acid | Total Organic |
|---|---|---|---|
| Sample | (%) | (%) | Acids (%) |
| 0% Fat Greek Yogurt Base | 2.583 | 0.217 | 2.8 |
| Starting Fermented Material | | | |
| Wash water after 1^{st} washing | 1.768 | 0.083 | 1.851 |
| Wash water after 2^{nd} washing | 1.465 | 0.068 | 1.533 |
| Wash water after 3^{rd} washing | 1.367 | 0.072 | 1.439 |
| Wash water after 4^{th} washing | 1.023 | 0.077 | 1.100 |
| Wash water after 5^{th} washing | 0.609 | 0.074 | 0.683 |
| Wash water after 6^{th} washing | 0.427 | 0.069 | 0.496 |
| Washed yogurt | 0.411 | 0.116 | 0.527 |

### Example 5—Tracking Carbohydrates, Sugar, Organic Acids and Protein Through Six-Stage Washing and Centrifugation

1) 1 volume of a commercially available 0% milk fat Greek yogurt (fermented dairy material) is provided and then mixed well with 0.15-0.3 volume of water to form a diluted Greek yogurt slurry.
2) The diluted Greek yogurt slurry is filtered through a 50 μm mesh diafiltration membrane to form a washed Greek yogurt white base and a filtrate (wash water).
3) To the washed Greek yogurt white base, additional water (0.15-0.3 volume) is added and stirred.
4) Steps 2 and 3 are repeated until the white base has been washed (i.e., diluted and filtered) six total times.
5) The six-time washed yogurt, without being further diluted, is centrifuged.

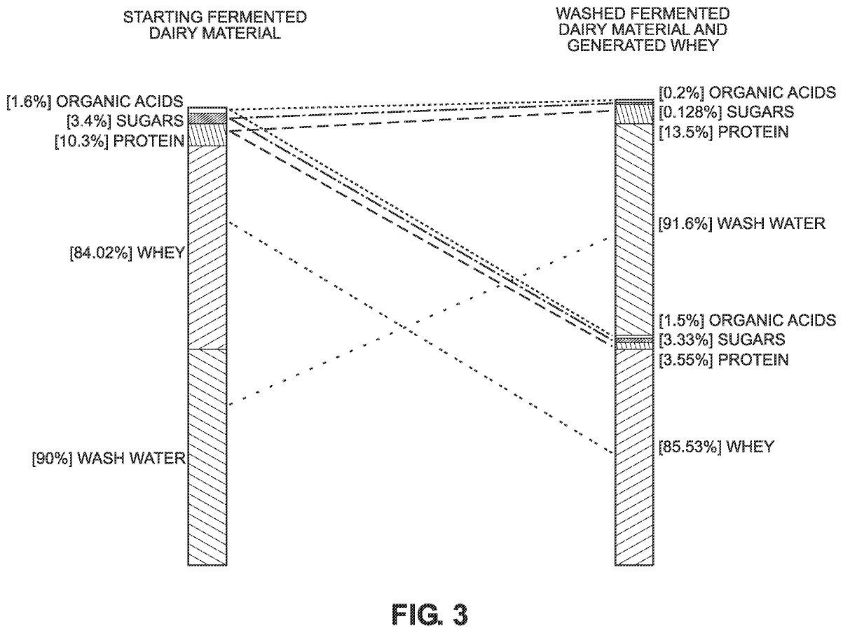

Table 5 shows the nutrient breakdown data and description for the starting fermented dairy material and the various white bases at different stages. FIG. 3 is a mass balance diagram showing the split of protein, sugars and organic acids from the starting fermented dairy material into the washed yogurt and the whey generated from washing. The “White Base After 6 Washes” sample is combined with a prep as further described in Examples 7 and 8. The “White Base After 6 Washes—Filtration+Centrifugation” sample is zero-net carb but can optionally be blended with a zero-carbohydrate prep (e.g., gelatin, water and flavor) to create a zero-net carb product.

TABLE 5

| | Total | Total | Organic | | Protein to | |
|---|---|---|---|---|---|---|
| | Carbohydrates | Sugars | Acids | Protein | Carbohydrate | |
| | (%) | (%) | (%) | (%) | Ratio | Description |
| 0% Fat Greek | 5 | 3.4 | 1.6 | 10.3 | 2.06 | Tangy and |
| Yogurt Base | | | | | | thick |
| Starting | | | | | | |
| Fermented | | | | | | |
| Material | | | | | | |
| White Base | 1.6 | 0.348 | 1.252 | 12.6 | 7.875 | Watery and |
| After 4 | | | | | | mild |
| Washes | | | | | | |
| White Base | 0.4 | 0.128 | 0.2 | 13.5 | 33.75 | A little |
| After 6 | | | | | | bland; soft |
| Washes | | | | | | texture like |
| | | | | | | cream |
| | | | | | | cheese |
| White Base | <LOQ | <LOQ | <LOQ | 25.2 | >63 | Thick and |
| After 6 | | | | | | dry (like |
| Washes- | | | | | | feta |
| Filtration + | | | | | | cheese), |
| Centrifugation | | | | | | very mild |

### Example 6—Separation of Yogurt Made from Ultrafiltered Milk

1) Unfermented ultrafiltered milk is provided, pre-inoculation
2) The unfermented ultrafiltered milk is fermented to create a yogurt (fermented dairy material)
3) The yogurt undergoes a first separation.
4) To the yogurt that has undergone the first separation, water (125% by weight of the separated yogurt) is added and stirred to form a diluted yogurt slurry.
5) The diluted yogurt slurry undergoes a second separation to form a washed yogurt white base.

Table 6 shows the total sugars and proteins for the various dairy materials during the process. After the second separation, the washed yogurt has below 0.29% total sugars, i.e., is zero-sugar. In this example, after the first separation, sugar in the fermented yogurt was reduced by 66.66% (from 0.59-0.61% to 0.20%). One could deduce that 66.66% sugar could similarly be removed from the starting fermented yogurt (i.e., from 0.70% sugar to 0.23% sugar) without the first separation step (i.e., following only one dilution step and subsequent separation step).

TABLE 6

| | Total | Total |
|---|---|---|
| Sample | Sugars % | Protein (%) |
| Ultrafiltered milk, pre- | 1.62 | 3.91-3.96 |
| inoculation, unfermented | | |
| Fermented yogurt made | 0.70-0.73 | 3.46-3.97 |
| from the ultrafiltered | | |
| milk, prior to 1^{st} washing | | |
| After 1^{st} separation | 0.59-0.61 | 9.16-9.35 |
| After 125% water dilution | 0.19 | 4.10-4.30 |
| following 1^{st} separation | | |
| After 2^{nd} separation | 0.20 | 11.60-11.80 |

### Example 7—Zero-Sugar Yogurt Product

The six-times washed yogurt from Example 5 (not centrifuged) (i.e., has 0.4% carbohydrates, 0.128% total sugars, etc.) is blended with a prep in two different ratios to produce two blended Zero-Sugar yogurt products. The prep includes: 0.5% guar gum, 2.86% allulose, 0.04% sucralose, 0.22% sea salt and 95.45% water. The first ratio, a 64/37 blend of washed yogurt/prep resulted in a product with acceptable texture, but the product melted too fast in the mouth and tasted like water. The second ratio, a 70/30 blend of washed yogurt/prep resulted in a product with good texture, body and taste. Table 7 shows the nutrient content of the 70/30 blend of washed yogurt/prep.

TABLE 7

| | 70/30 Blend |
|---|---|
| Total Carbohydrates (%) | 1.5 |
| Total Sugars (%) | <LOQ |
| Organic Acids (%) | 0.109 |
| Protein (%) | 8.89 |
| Protein to Carb Ratio | 5.93 |
| Calories per 150 g | 63 |
| Serving | |
| Sugars (g) per 150 g | 0 |
| Serving | |
| Protein (g) per 150 g | 13 |
| Serving | |

### Example 8—Zero-Net Carb Yogurt Product

The six-times washed yogurt from Example 5 (not centrifuged) (i.e., has 0.4% carbohydrates, 0.128% total sugars, etc.) is blended with a zero-net carb prep to achieve a zero-net carb yogurt product. In particular, 105 g of the washed yogurt (0.4% total carbohydrates, or 0.42 g carbohydrates) is blended with 45 g of a zero-net carb prep (i.e., a 70/30 blend) to produce a 150 g serving of a zero-net carb yogurt product.

### Example 9—Inventive Yogurt Product Compared to Prior Art Yogurt

Table 8 shows the nutrient content of an inventive vanilla flavored yogurts compared to prior art vanilla or strawberry flavored yogurts, both of which are marketed as having no sugar. As shown, the inventive product is truly zero-sugar.

TABLE 8

| | Carbo- | Organic | | Total | Protein to | |
|---|---|---|---|---|---|---|
| | hydrates | Acids | Protein | Sugars | Carb | |
| Sample | (%) | (%) | (%) | (%) | Ratio | pH |
| Comparative- | 4.2 | 0.792 | 8.02 | 0.172 | 1.91 | 4.48 |
| Vanilla | | | | | | |
| Flavored | | | | | | |
| Comparative- | 4 | 0.875 | 7.86 | 0.179 | 1.97 | N/A |
| Strawberry | | | | | | |
| Flavored | | | | | | |
| Inventive- | 1.5 | 0.101 | 8.89 | 0 | 5.93 | 3.87 |
| Vanilla | | | | | | |
| Flavored | | | | | | |

Although described with reference to particular embodiments of the invention, it should be understood that various changes and/or modifications can be made to the invention without departing therefrom as encompassed by the following claims.

1. A method of making a zero-sugar and zero-net carb dairy product, the method comprising:
a) providing a fermented dairy material having sugars and organic acids;
b) adding a first volume of a dilution liquid to the fermented dairy material to form a first diluted dairy slurry;
c) separating the first diluted dairy slurry into a first washed fermented dairy material and a first filtrate;
d) adding a second volume of the dilution liquid to the first washed fermented dairy material to form a second diluted dairy slurry; and
e) separating the second diluted dairy slurry into a second washed fermented dairy material and a second filtrate.

2. The method of claim 1, wherein the fermented dairy material is an animal-derived yogurt or a non-animal-derived yogurt.

3. The method of claim 1, wherein the zero-sugar and zero-net carb dairy product is an animal-derived cream cheese or a non-animal-derived cream cheese.

4. The method of claim 1, wherein the second volume of the dilution liquid is smaller than the first volume of the dilution liquid.

5. The method of claim 1, wherein the first volume of the dilution liquid is 15-50% of the volume of the fermented dairy material provided in step a).

6. The method of claim 1, wherein at least part of the first filtrate is recycled into part or all of the second volume of the dilution liquid.

7. The method of claim 1, wherein step c) is performed by centrifugation.

8. The method of claim 1, wherein steps c) and e) are each performed using one or more ultrafiltration membranes.

9. The method of claim 1, further comprising:
f) adding a third volume of the dilution liquid to the second washed fermented dairy material to form a third diluted dairy slurry;
g) separating the third diluted dairy slurry into a third washed fermented dairy material and a third filtrate; and, optionally
h) adding a fourth volume of the dilution liquid to the third washed fermented dairy material to form a fourth diluted dairy slurry; and
i) separating the fourth diluted dairy slurry into a fourth washed fermented dairy material and a fourth filtrate,
wherein the third and/or the fourth washed fermented dairy material has an organic acid content of 0.7 wt % or less and at least 60% fewer sugars than the fermented dairy material.

10. The method of claim 9, further comprising:
j) adding a prep to the fourth washed fermented dairy material.

11. A system for making a zero-sugar and zero-net carb dairy product, the system comprising:
a first separation stage including
an inlet for a fermented dairy material having sugars and organic acids;
an inlet for a first volume of a dilution liquid;
one or more filtration membranes;
an outlet for a first washed fermented dairy material; and
an outlet for a first filtrate; and
a second separation stage including
an inlet for a first washed fermented dairy material;
an inlet for a second volume of a dilution liquid;
one or more filtration membranes;
an outlet for a second washed fermented dairy material; and
an outlet for a second filtrate.

12. The system of claim 11, wherein the one or more filtration membranes are spiral wound, plate and frame, or ceramic filtration membranes.

13. The system of claim 11, wherein the first separation stage is configured to perform diafiltration.

14. A zero-sugar and zero-net carb dairy product comprising:
a washed fermented dairy material that has an organic acid content of 0.7 wt % or less and a weight ratio of protein to carbohydrate of at least 7.8:1.

15. The zero-sugar and zero-net carb dairy product of claim 14, further comprising a prep.

16. The zero-sugar and zero-net carb dairy product of claim 15, wherein 65-75% of the dairy product is the washed fermented dairy material and 25-35% of the dairy product is the prep.

17. The zero-sugar and zero-net carb dairy product of claim 14, wherein the dairy product is an animal-derived yogurt or a non-animal-derived yogurt.

18. The zero-sugar and zero-net carb dairy product of claim 14, wherein the dairy product is an animal-derived cream cheese or a non-animal-derived cream cheese.
